(19) United States
(12) Patent Application Publication
(10) Pub. No.: US 2008/0113159 A1
(43) Pub. Date: May 15, 2008

(54) Stainless sheet for a tool cabinet

(76) Inventor: George C.M. Liu, Dou-Liou City (TW)

Correspondence Address: Thomas E. Sisson;Jackson Walker, LLP, Suite 2400, 112 E. Pecan, San Antonio, TX, 78205, US

(21) Appl. No.: 11/595,755

(22) Filed: Nov. 9, 2006

(51) Int. Cl. B32B 15/04

(52) U.S. Cl. 428/142; 428/457

(57) ABSTRACT

A stainless sheet for a tool cabinet has an external surface and a transparent painting layer. The external surface is rough, and the transparent painting layer is formed on the rough external surface.

### BACKGROUND OF THE INVENTION

1. Field of the Invention

The present invention relates to a stainless sheet, and more particularly to a stainless sheet for a tool cabinet that can be used and cleaned conveniently and easily.

2. Description of Related Art

Conventional tool cabinets are used to store hand tools or instruments and have many types. A conventional tool cabinet for storing tools and instruments substantially has a body, multiple drawers and multiple wheels. The body may be rectangular and has a chamber and a bottom. The drawers are slidably mounted in the chamber of the body and allow users to store and classify the hand tools or instruments. The wheels are mounted on the bottom of the body to make the conventional tool cabinet being moved easily.

In general, the conventional tool cabinet is made of stainless sheets. However, when users touch the conventional tool cabinet, the fingerprints and greasy dirt are easily left the body of the tool cabinet made of stainless sheets. Furthermore, the conventional tool cabinet made of stainless sheets may be still rusted when the conventional tool cabinet is near an acid or saline environment.

To overcome the shortcomings, the present invention provides a stainless sheet for a tool cabinet that can be used and cleaned conveniently and easily.

### SUMMARY OF THE INVENTION

The main objective of the present invention is to provide a stainless steel for a tool cabinet that can be cleaned conveniently and easily.

The stainless sheet for a tool cabinet has an external surface and a transparent painting layer. The external surface is rough, and the transparent painting layer is formed on the rough external surface.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a tool cabinet made of stainless sheets in accordance with the present invention;

FIG. 2 is an enlarged cross section view of the stainless sheet for a tool cabinet in FIG. 1; and

FIG. 3 is a block diagram of a process for manufacturing the stainless sheet in FIG. 1.

### DETAILED DESCRIPTION OF THE PREFERRED EMBODIMENT

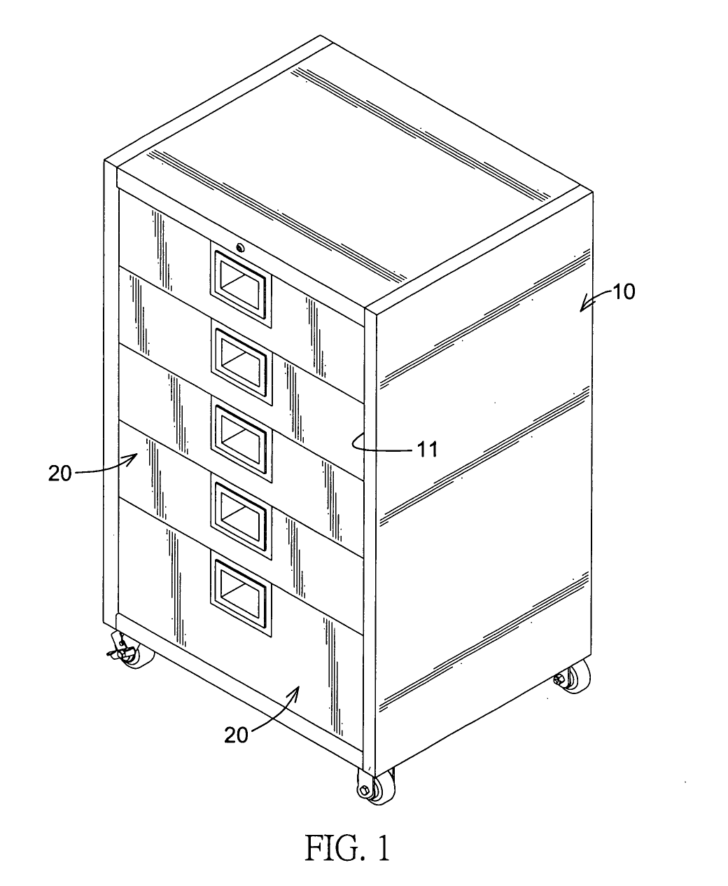

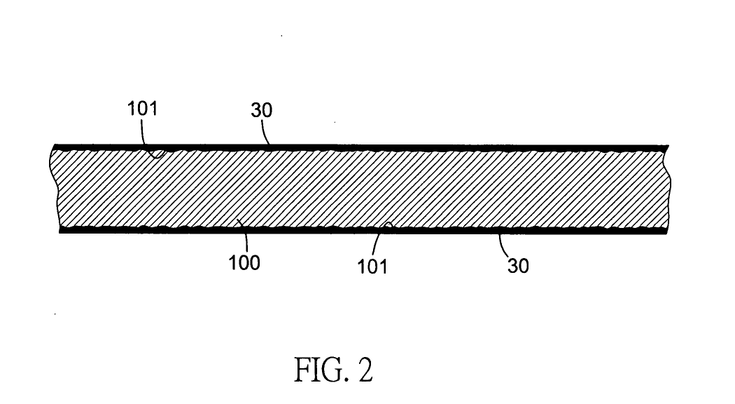

With reference to FIGS. 1 and 2, a stainless sheet (100) in accordance with the present invention for a tool cabinet having a body (10), multiple drawers (20) and multiple wheels comprises an external surface (101) and a transparent painting layer (30).

The body (10) may be rectangular and has a chamber, a front side, an opening (11) and a bottom. The chamber is defined in the body (10). The opening (11) is defined in the front side of the body (10) and communicates with the chamber. The drawers (20) are slidably mounted in the chamber of the body (10) and allow users to store and classify hand tools or instruments. The wheels are mounted on the bottom of the body (10) to make the body (10) being moved easily. The body (10) and drawers (20) are made of stainless sheets (100).

With reference to FIG. 2, the external surface (101) may be rough, the transparent painting layer (30) is formed on the rough external surface (111). The roughness of the external surface (101) will increase the combination of the transparent painting layer (30) with the external surface (101). The transparent painting layer (30) can prevent dust or greasy dirt from being attached onto the stainless sheet (100) and the users can clean dust, dirty and the fingerprints on the transparent painting layer (30) conveniently and easily. Furthermore, the transparent painting layer (30) can prevent the stainless sheet (100) from rusting in an acid or a saline environment.

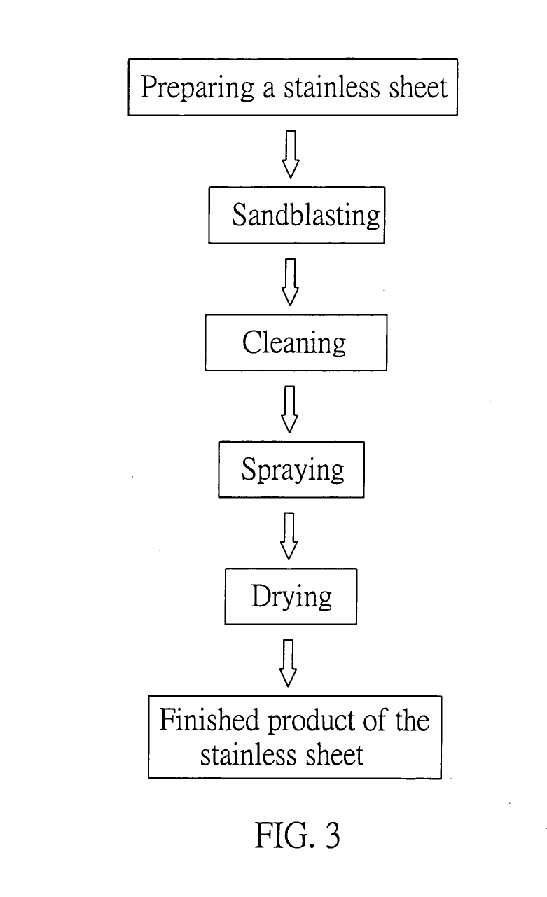

With reference to FIG. 3, to manufacture the stainless sheet (100), a stainless sheet (100) is prepared and the external surface (101) of the stainless sheet (100) is roughened with a sandblasting process. Then, the external surface (101) is cleaned to remove dust and dirt generated between the sandblasting process. After coating paint onto rough external surface (101) with a spraying process to form the transparent painting layer (30), the stainless sheet (100) is dried at the temperature between 140° C. to 250° C. Accordingly, a finished product of the stainless sheet (100) with a transparent painting layer (30) is completed.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A stainless sheet for a tool cabinet having an external surface; and
a transparent painting layer being formed on the external surface of the stainless sheet.

2. The stainless sheet for a tool cabinet as claimed in claim 1, wherein the external surface is rough.
